(19) United States
(12) Patent Application Publication
(10) Pub. No.: US 2024/0162664 A1
(43) Pub. Date: May 16, 2024

(54) Grounding Connector System

(71) Applicant: ERICO International Corporation, Solon, OH (US)

(72) Inventors: Gregory D. Holder, Chagrin Falls, OH (US); Dale Boling, Avon, OH (US); Marianna Palmer, Chesterland, OH (US)

(21) Appl. No.: 18/508,688

(22) Filed: Nov. 14, 2023

Related U.S. Application Data
(60) Provisional application No. 63/383,741, filed on Nov. 15, 2022.

(51) Int. Cl. H01R 13/652

(52) U.S. Cl. CPC H01R 13/652

(57) ABSTRACT

A connector system to provide electrical connections can include a base and a plug. The base can include a base body, a base bore that can extend axially into the base body along a base axis, a lay-in slot that can open at a sidewall of the base body, and a base conductor channel that can be formed by the lay-in slot and intersects the base bore. The plug can have a first end that can be sized to be received in the base bore. The base conductor channel can receive a longitudinal portion of a conductor into the lay-in slot so that the conductor extends through the base conductor channel to intersect the base bore. In an assembled configuration, the first end of the plug can extend into the base bore, aligned with the conductor along the base axis to deform the conductor in the axial direction.

### CROSS REFERENCE TO RELATED APPLICATIONS

This application claims priority to U.S. Provisional Application No. 63/383,741, entitled “GROUNDING CONNECTOR SYSTEM” and filed Nov. 15, 2022, the entirety of which is incorporated herein by reference.

### BACKGROUND

In different contexts, it may be beneficial (e.g., for compliance with code standards) to provide electrical grounding for conductors. To provide grounding connections, for example, grounding connectors can secure wires or other conductors (e.g., cables) to a conductive body (e.g., a part of the grounding connector, in turn connected to a grounding rod or other grounded component). Generally, grounding connectors provide a mechanically secured electrical grounding connection (i.e., connection to electrical ground) for conductors.

### SUMMARY

Examples according to this disclosure can provide connector systems, including a variety of components that may be assembled together, for providing electrical grounding connections. For example, some implementations disclosed herein can provide a connector system configured to secure a portion of a conductor that can be secured to one or more other connector systems that collectively form a conductor system.

In one example, a connector system to provide electrical grounding connections can includes a base and a plug. The base can include a base body, a base bore that can extend into the base body along a base axis that defines an axial direction, a lay-in slot that can open at a sidewall of the base body and can form a base conductor channel that intersects the base bore. The plug can have a first end with a first diameter that can be sized to be received in the base bore, and a second end, axially opposite the first end. The base conductor channel can receive a longitudinal portion of a conductor into the lay-in slot at the sidewall so that the conductor extends through the base conductor channel to intersect the base bore. In an assembled configuration, the first end of the plug can extend into the base bore, with the plug aligned with the conductor along the base axis to deform the conductor in the axial direction.

In some examples, the lay-in slot can have a first portion that can extend into the sidewall of the base body substantially perpendicular to the base axis and a second portion that can extend from the first portion substantially parallel to the base axis and along the base bore, and an inner end of the second portion of the lay-in slot can define a seat portion of the base conductor channel that receives the conductor in the assembled configuration. In some such examples, the first portion of the lay-in slot can have a first width and the second portion of the lay-in slot can have a second width that is the same as the first width. In some such examples, the inner end of the second portion of the lay-in slot can be axially aligned with the base axis. In some such examples, the base bore can define a crimping area that can extend axially past the seat portion of the lay-in slot to receive the axial deformation of the conductor. In some such examples, the crimping area can include an axially extending conical surface extending axially at an inner end of the base bore. In some such examples, an angle of the conical surface of the base bore measured relative to the base axis can be in a range between about 55 degrees and about 70 degrees.

In some examples, the connector system can further include a grounding rod that can have a first end that can be coupled to the base at one end and a second end that can be insertable into a ground surface. In some such examples, the base bore can be a first base bore extending axially into the base body at a first axial end, and the base can further include a second base bore that can extend axially into the base body at a second axial end opposite the first axial end and can receive the first end of the grounding rod. In some such examples, the second base bore can be a tapered bore, and the first base bore may not be a tapered bore.

In some examples, the connector system can further include a cap that can include a cap body, a cap bore that can extend axially into the cap, and a cap conductor channel that can intersect the cap bore. The conductor can be a first conductor, and the second end of the plug can have a second diameter sized to be received within the cap bore. In the assembled configuration, the second end of the plug can be secured in the cap bore, aligned with the cap conductor channel along the base axis that can deform a second conductor extending through the cap conductor channel. In some such examples, the lay-in slot of the base can be a first lay-in slot, and the cap conductor channel can be formed by a second lay-in slot that can open at a sidewall of the cap body and can be configured to receive a longitudinal portion of the second conductor so that the second conductor extends through the cap conductor channel to intersect the base bore. In some such examples, the cap conductor channel can be formed by a first conductor bore and a second conductor bore that can extend into opposing sides of the cap body and intersect the cap bore. In some such examples, an axis defined by the first conductor bore can be substantially parallel to an axis defined by the second conductor bore. In some such examples, the first diameter of the first end of the plug can be larger than the second diameter of the second end of the plug. In some such examples, the plug can further include a central portion with a third diameter that can be larger than the first diameter, and the central portion of the plug can be seated on the base in the assembled configuration.

In another example, a method of electrically grounding one or more conductors can include inserting a longitudinal portion of a conductor into a lay-in slot that opens at a sidewall of a base body of a connector system, and sliding the longitudinal portion of the conductor along a base conductor channel formed by the lay-in slot, so that the conductor intersects a first base bore that extends in an axial direction into the base body from a first end of the base body. The method can further include inserting a first end of a plug of the connector system that has a first diameter into the base bore at the first end of the base body. A second end of the plug, opposite the first end, can be hammered to place the connector system in an assembled configuration in which the first end of the plug is secured within the first base bore and is aligned with the conductor along the base axis to deform the conductor in the axial direction.

In some examples, the method can further include, before hammering the second end of the plug, inserting an end of a grounding rod into a second base bore of the base body that extends into the base body at a second end of the base body, opposite the first end.

In yet another example, a connector system to provide electrical grounding connections can include a base, a plug, and a grounding rod. The base can include a base body, a first base bore that can extend into the base body along a base axis at a first axial end of the base, a second base bore that can extend axially into the base body at a second axial end opposite the first axial end, and a base conductor channel that can be formed by a lay-in slot and intersects the base bore. The plug can have a first end that can be sized to be received in the base bore, and a second end, axially opposite the first end. The grounding rod can have a first end that can be received with the second base bore and a second end that can be insertable into a ground surface. The lay-in slot includes an opening at a sidewall of the base body that can receive a longitudinal portion of a conductor into the base conductor channel, a first portion that can extend from the opening transverse to the base axis, and a second portion that can extend from the first portion along the base bore to a seat portion at an inner end of the lay-in slot. In an assembled configuration, the longitudinal portion of the conductor can be seated on the seat portion and the first end of the plug can extend within the base bore to deform the conductor axially past the seat portion.

In some examples, the connector system can further include a cap that can include a cap body, a cap bore that can extend axially into the cap body, and a cap conductor channel that intersects the cap bore. The conductor can be a first conductor, and the second end of the plug can be sized to be received within the cap bore. In the assembled configuration, the second end of the plug can extend within the cap bore to deform a second conductor that extends through the cap conductor channel.

Other aspects of the disclosed technology, including particular features and advantages thereof, will become apparent to one of ordinary skill in the art upon examination of the figures and detailed description herein.

### BRIEF DESCRIPTION OF THE DRAWINGS

FIG. 1 is a side view of a connector system in an assembled configuration according to examples of the present disclosure;

FIG. 2 is a side plan view of an example plug of the connector system of FIG. 1;

FIG. 3 is an isometric view of another example connector system in an assembled configuration according to examples of the present disclosure;

FIG. 4 is a cross-sectional view taken along line 4-4 of FIG. 3;

FIG. 5 is a perspective view of yet another example connector system in a first assembled configuration according to examples of the present disclosure;

FIG. 6 is an isometric view of the connector system of FIG. 5 in an assembled, ganged configuration according to examples of the present disclosure;

FIG. 7 is a cross-sectional view taken along line 7-7 of FIG. 6;

FIG. 8 is an isometric view of another example connector system, with a cap structure thereof shown in phantom lines, in an assembled configuration, according to example of the present disclosure;

FIG. 9 is a cross-sectional exploded view taken along line 9-9 of FIG. 8, with the cap structure removed;

FIG. 10 is an exploded partly schematic view of yet another example connector system in a ganged configuration with a first sub-assembly and a second sub-assembly that include a plug and a base, respectively;

FIG. 11A is a perspective partly schematic view of the connector system of FIG. 10 in a first assembled configuration;

FIG. 11B is a perspective partly schematic view of the connector system of FIG. 10 in a second assembled configuration;

FIGS. 12A and 12B are side partial view of example configurations of first and second conductor channels of a base body according examples of the present disclosure; and

FIG. 12C is a cross-sectional view taken along line 12C-12C of FIG. 12B.

### DETAILED DESCRIPTION OF THE DRAWINGS

Before any examples of the disclosed technology are explained in detail, it is to be understood that the disclosure is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present disclosure and accompanying figures relate generally to grounding connectors, including grounding connectors that utilize shear bolts and lay-in grounding connectors. Although examples of grounding connectors are disclosed with reference to particular installation contexts, the concepts disclosed herein can be applied for connectors in a wide range of applications.

As generally noted above, grounding connections for conductors can be useful in a variety of contexts. To ensure appropriate grounding connections, it is important to appropriately mechanically secure conductors to grounding connectors. For example, some code requirements may require that grounding connectors provide at least a minimum force to detach grounded conductors from the grounding connector (e.g., a minimum permissible pull-out load).

Using conventional grounding connectors, it may be difficult to connect multiple conductors to a relevant grounding (or other) body. Conventional designs also generally do not allow for easy expansion of grounding systems. For example, using conventional grounding connectors, it may be difficult to add additional conductors to a grounding (or other) connection assembly without removing or replacing existing connectors.

In this regard, some examples disclosed herein can include grounding connectors that can secure wires or conductors to a conductive body relatively securely and that can be ganged together (e.g., hammer-drivable into a stacked configuration) to allow users to easily expand the number of connections for existing grounding connections or easily include multiple conductors in an initial (or subsequent) installation.

In some examples, a grounding connector disclosed herein can secure conductors using mechanical engagement (e.g., frictional or deforming contact) between a plug and a connector body. In some configurations, for example, a cylindrical plug can be sized to be received into a corresponding bore of one of more connector bodies (e.g., two connector bodies at the same time), to thereby secure one or more respective conductors to the relevant connector. In some cases, two connector bodies can be secured together (e.g., with a common plug) to thereby secure various conductor arrays to the respective connector bodies as well as to itself provide a conductive connection between the secured conductors via the connector bodies.

In some examples, connector bodies can be formed as caps, with an anvil surface for hammering the cap into engagement with a corresponding plug or other base assembly. For example, some caps can include a flattened area on an end opposite the opening that receives a plug, to be hammered to secure the cap into an engaged configuration. In some examples, connector bodies can be formed as bases, configured to be secured to a grounding rod or another object (e.g., also by hammering). For example, a first opening on a base (e.g., a tapered bore) can be configured to engage a grounding rod and a second opening on an opposing end of the base (e.g., a non-tapered bore) can be configured to receive a plug to secure a conductor.

As used herein, terms such as “base” and “cap” can provide a useful reference frame relative to particular installed configurations. In this regard, as described herein, base generally refers to a lower connector body that is positioned below another connector body, and cap generally refers to an upper connector body that is positioned above another connector body. For example, a base connector body can be secured to a grounding rod at a first end, and can receive a plug into second end to secure one or more conductors to the grounding rod via the base connector body. Further, in some examples, a cap can be secured to such a base connector body (e.g., via the plug noted above) to thereby connect additional conductors to the grounding rod and base connector assembly (e.g., as a retrofit expansion of an already installed system). However, unless otherwise noted, use of “base” and “cap” to describe a particular component is not intended to be limiting relative to the particular orientation of a particular connector body within a larger system. For example, two caps from the example above can be secured together in some configurations, or a second base connector body can be secured to the base connector assembly in place of the noted cap.

Generally, both bases and caps can have conductor channels that extend through the connector body to intersect the openings that receive the plugs (e.g., formed as transverse bores through a connector body). Accordingly, for example, a plug received into a connector body can mechanically engage a conductor (e.g., solid or stranded cable) that is receive through the corresponding conductor holes and thereby secure the conductor to the connector body. In some cases, a recessed crimping area along an opening that receives a plug can be generally aligned with (e.g., intersected by or adjacent to) a conductor channel, so that full insertion of the plug into the opening can cause the conductor to be deformed into the crimping area.

In different examples, different modular connection assembly can be assembled, including with connector bodies that are formed with lay-in slots, are configured to receive grounding rods, or are gangable with each other or relative to preinstalled connection assemblies. Generally, in this regard, a wire or other conductor can be inserted into a conductor channel (e.g., lay-in slot) that intersects a bore of a conductor body (e.g., of a base or a cap), and a plug can be fitted into the bore. The connector body and the plug can then be secured together to secure the conductor in place, including by hammering an end of the plug or of the connector body to drive the plug into the bore. Generally, the corresponding conductor can thus be pressed firmly into the plug and the connector body so that a reliable and mechanically secure electrical connection is formed. In some configurations, particularly arranged plugs can secure first conductors to first connector bodies and simultaneously also secure second conductors to second connector bodies (e.g., and thereby also secure the connector bodies together). In some examples, a plug can be positioned between two connector bodies so that the plug can be driven co-axially into a bore of each connector body with a single-direction hammer blow. The connector bodies can then be readily hammered together or, as applicable, the plug can first be hammered into a first connector body and then a second connector body can be hammered onto the first and the plug (or vice versa).

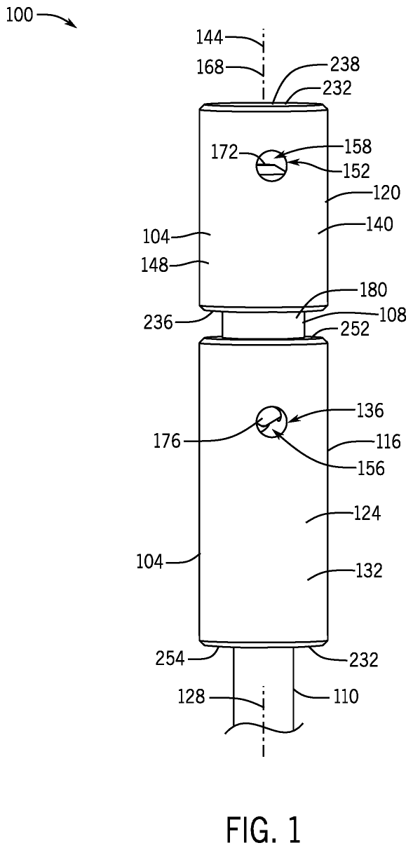

FIG. 1 illustrates an example assembled configuration of a connector system 100 that includes two connector bodies 104, a plug 108 arranged between the connector bodies 104, and a grounding rod 110 coupled (e.g., fixedly) with one of the connector bodies 104. In the illustrated example, one of the connector bodies 104 is a configured as a grounding-rod base 116 coupled with the grounding rod 110, and the other connector body 104 is configured as an expansion cap 120 that is secured to the grounding rod 110 by the base 116 (and on an opposite side of the base 116 from the grounding rod 110). The grounding rod 110 may be configured to be inserted into a ground surface (not shown) to provide the connector system 100 with a grounding connection therewith. In other configurations, including as discussed below, other configurations of the connector system 100 can include multiple caps (e.g., two or more of the caps 120), multiple bases (e.g., two or more of the bases 116) or various other connector bodies. In some cases, the connector system 100 may not include the grounding rod 110.

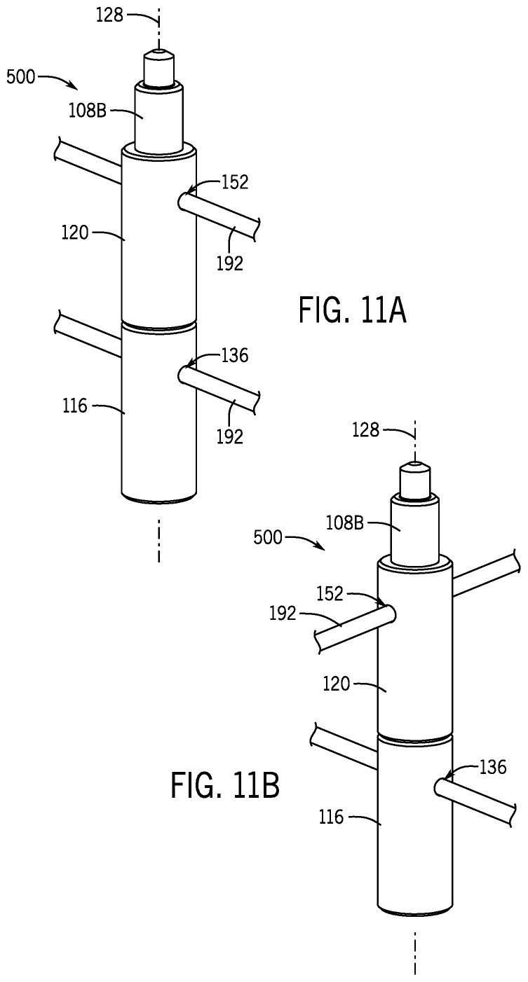

In the illustrated example of FIG. 1, the base 116 has a base body 124 that defines a base axis 128 and a base sidewall 132. A base conductor channel 136 extends radially into the sidewall 132 of the base body 124 to intersect a base bore 156 that extends axially partly into the base body 124 along the base axis 128, starting from a first base end 252 opposite a second base end 254. The cap 120 has a cap body 140 that defines a cap axis 144 and a cap sidewall 148. Similar to the base conductor channel 136 of the base 116, in the illustrated example, the cap 120 has a cap conductor channel 152 that extends radially into the cap body 140 to intersect a cap bore 158 that extends axially partly through the cap body 140 (e.g., along the cap axis 144 from a first cap end 236 toward an opposite second cap end 238. As described in more detail below, the base conductor channel 136 of the base 116 and the cap conductor channel 152 of the cap 120 can each receive a respective conductor (e.g., one of the wires 192 shown in FIGS. 11A and 11B) so that the conductor extends through the sidewalls 132, 148 to intersect the respective bore 156, 158.

Generally, the connector system 100 can be configured to secure at least one conductor (e.g., stranded or solid wire) and can include various combinations of at least one plug and at least one base or at least one cap. It should also be appreciated that the base 116 and the cap 120 can be configured differently than illustrated in FIG. 1. For example, in some cases, one or both of the base 116 and the cap 120 can include multiple bores or multiple conductor channels, or may include conductor channels formed from lay-in slots (e.g., as further discussed below). In some cases, the base 116 can include a second base conductor channel (not shown) that can receive a second conductor, or the cap 120 can include a second cap bore (not shown) opposite the cap bore 158 configured to receive a second plug.

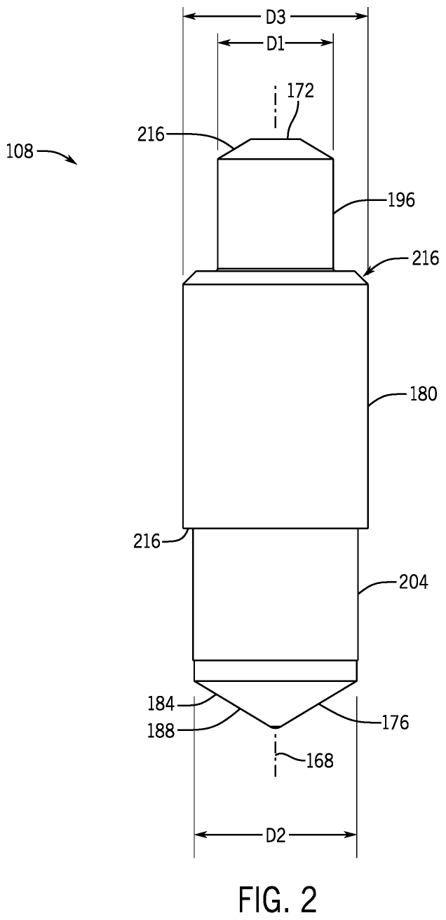

As shown in FIG. 2 in particular, the plug 108 has a first end 172, a second end 176 opposite the first end 172, a central portion 180 positioned between the first and second ends 172, 176, and defines a plug axis 168 extending through the first and second ends 172, 176. The plug 108, the base sidewall 132, and the cap sidewall 148 are generally cylindrical in shape, although non-circular cross-sectional profiles are possible in some cases. In the assembled configuration, the plug 108 is positioned between the base 116 and the cap 120, and the plug axis 168, the cap axis 144, and the base axis 128 are aligned in parallel (e.g., coaxially). Thus, the plug 108 can be received within each of the base bore 156 of the base 116 and the cap bore 158 of the cap 120, such that hammer impacts at the first end 172 of the plug 108 (or other similar application of force onto the system 100) can drive the plug 108 into the cap and plug bores 156, 158 (e.g., simultaneously or sequentially) until the second end 176 of the plug 108 contacts inner ends of the cap and plug bores 156, 158 or other structure (e.g., the material of an inserted conductor) that limits further insertion of the plug 108. This hammer-driven movement of the plug 108 can in turn compress a respective conductor (.g., one of the wires 192 shown in FIGS. 11A and 11B) between the plug 108 and the respective connector body 104 and thereby securely electrically and mechanically connect the conductors to each other, as well as to the system 100 as a whole.

In some examples, such a movement of a plug can be caused by hammer blows onto anvil surfaces on either axial end of a connector system (e.g., at anvil surfaces 232 on opposing ends of axially opposed connector bodies). As described in more detail below, in some examples, one or more of the base ends 252, 254 of the base 116, the cap ends 236, 238 of the cap 120, or the ends 172, 176 of the plug 108 may be configured as anvil surfaces 232.

In some examples, a plug according to the disclosed technology can be configured to be received into bores of opposing connector bodies (e.g., a base and a cap, as shown in FIG. 1), so that relatively coarsely controlled axial impacts can move the plug within the bores to securely connect associated conductors. In this regard, FIG. 2 further illustrates certain useful geometrical aspects of an example configuration of the plug 108. For example, the first end 172 of plug 108 is flattened or planar, as can be particularly suitable for receiving a blow from a hammer (or other impacting instrument), as well as for securing conductors (e.g., wires 192 as shown in FIGS. 11A and 11B). Further, the second end 176 of plug 108 includes a tapered projection 184 that defines a crimping face 188 that may be suitable for more aggressive impingement of a conductor (e.g., the wires 192 of FIGS. 11A and 11B). In other examples, other profiles on particular ends of a plug are also possible (e.g., profiles exhibiting more or less taper at either of the ends 172, 176 of plug 108).

In some examples, plugs of a connector system having varied diameters can provide for improved installation and more secure retention of connections thereafter. For example, in the illustrated implementation, a first sidewall 196 of the plug 108 extends between the first end 172 and the central portion 180, and has a first diameter D1 at a widest portion of the first sidewall 196. A second sidewall 204 is defined between the crimping face 188 and the central portion 180, and has a second diameter D2 at a widest portion of the second sidewall 204. The central portion 180 extends axially between the first and second ends 172, 176 and has a third diameter D3 at a widest portion of the central portion 180. In some cases, a difference between the third diameter D3 and either of the first or second diameters D1, D2 can provide a positive stop against over-insertion of the plug 108 into a bore of a connector body (e.g., the base bore 156 of the base 116 or the cap bore 158 of the cap 120 of FIG. 1).

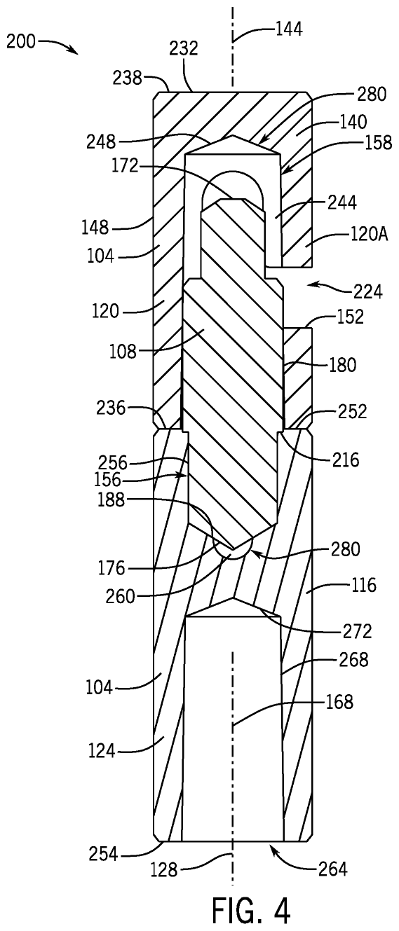

In one example, at least one of the first sidewall 196, the second sidewall 204, and the central portion 180 of the plug 108 is tapered (e.g., linearly sloped with respect to the plug axis 168). In another example, at least one of the first sidewall 196, the second sidewall 204, and the central portion 180 of the plug 108 is not tapered (e.g., extends parallel to the plug axis 168). Correspondingly, bores of associated connector bodies can be tapered or not tapered in different examples, as can provide more or less aggressive holding force, respectively, for a plug inserted within a bore to a particular depth. In one example, one or more shoulders 216 may be located at the transition between the central portion 180 and either the first sidewall 196 or the second sidewall 204, between the first sidewall 196 and the first end 172, or between the second sidewall 204 and the tapered projection 184. Generally, the one or more shoulders 216 provide a dimensional transition between the various portions of the plug 108 and can extend a shorter distance along the plug axis 168 than the first sidewall 196, the second sidewall 204 or the central portion 180. As similarly noted above, relative the differences in the diameters D1, D2, D3, the contours provided by the one or more shoulders 216 can thus, in some cases, provide a positive stop against over-insertion of the plug 108 within one or both of the base bore 156 or the cap bore 158 (e.g., as shown in FIG. 4 relative to the base 116).

In the illustrated example, the first sidewall 196, the second sidewall 204, and the central portion 180 are generally cylindrical in shape and each are centered around the plug axis 168. Likewise, the third diameter D3 is greater than each of the first diameter D1 and the second diameter D2. In other examples, the first diameter D1 may be greater than or the same as the second diameter D2.

In one example, to assemble the base 116, the cap 120, and the plug 108 in the assembled configuration (as shown in FIG. 1), the plug 108 may be inserted between the cap 120 and the base 116, and then the cap 120 or the base 116 may be struck with a hammer (or another similar impingement device). In such examples, one or both of the base 116 or the cap 120 may be configured such that the above described striking force on the base 116 or the cap 120 mechanically compresses the plug 108, the base 116, and the cap 120 together into the assembled configuration (as shown in FIG. 1).

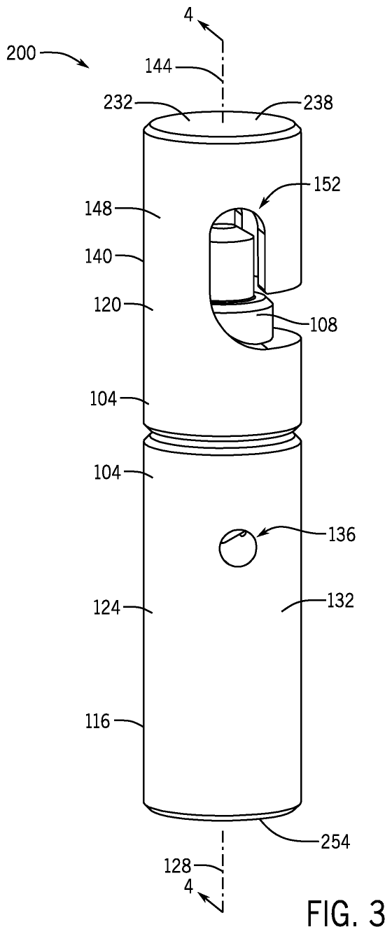

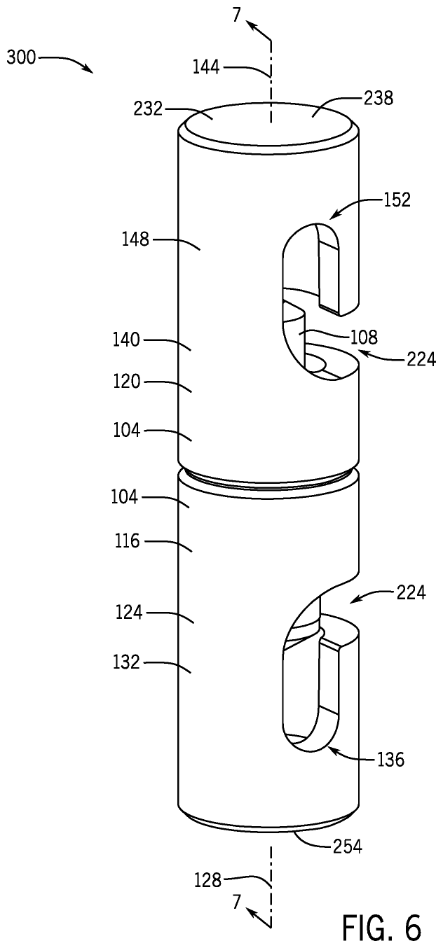

In another example, hammer blows (or other striking forces) on the first end 172 of the plug 108 can secure the cap 120 or the base 116 to the plug 108 to form an assembled configuration similar to the assembled configurations shown in FIGS. 3 and 6. The other connector body 104 (e.g., the base 116 or the cap 120) can then be seated onto the plug 108 and further strikes on the connector body 104 or the connector body 104 can result in the assembled configuration as shown in FIG. 1 (i.e., with the two connector bodies 104 secured to the plug 108, and the plug axis 168 aligned with the base axis 128 and the cap axis 144). In this regard, for example, the selection of a tapered (or straight) profile for the first or second sidewalls 196, 204, or of either of the bores 156, 158 can facilitate particularly easy or secure engagement of the plug 108 to the other connector body 104.

FIGS. 3 and 4 illustrate another connector system 200 configured in an assembled configuration (as shown in FIGS. 3 and 4) with the plug 108 inserted between the base 116 and the cap 120. In the example illustrated in FIG. 3, the cap 120 is generally similar to the example illustrated in FIG. 1, but has the cap conductor channel 152 formed into the cap body 140 as a lay-in feature in place of the closed-bore configuration of the channel 152 shown in FIG. 1. In particular, the lay-in feature includes a curved slot 224 formed in the cap body 140 and open at the cap sidewall 148. A conductor (e.g., the wires 192 of FIGS. 11A and 11B) can thus be inserted axially or can be laid laterally into the slot 224 to align the conductor within the cap 120 for engagement by the plug 108.

As also shown in FIG. 4 in particular, the plug 108 and the cap 120 are configured to engage one or more conductors between an inner end 248 of the cap bore 158 and the first end 172 of the plug 108. In one example, the conductor 192 can be first inserted into the cap conductor channel 152 and then the plug 108 and the cap 120 can be compressed axially together to physically secure the conductor 192 between the plug 108 and the cap 120 within the cap bore 158 with a reliable and secure electrical connection. In one example, the inner end 248 of the cap bore 158 intersects the cap axis 144 and tapers from a cap bore sidewall 244 toward the cap axis 144.

Also as shown in FIGS. 3 and 4 in particular, the base body 124 defines the first and second base ends 252, 254 that are arranged opposite one another along the base axis 128. The first base end 252 includes the first base bore 156, with a first base bore sidewall 256 and a first base bore inner end 260. The base end 254 defines a second base bore 264 with a second base bore sidewall 268 and a second base bore inner end 272. In one example, the cap bore sidewall 244, the first base bore sidewall 256, and the second base bore sidewall 268 are centered around the cap axis 144, the base axis 128, and the plug axis 168 when the connector system 200 is arranged in the assembled configuration (as shown in FIGS. 3 and 4). The first base bore 156 extends axially opposite the second base bore 264 along the base axis 128. In some cases, the base bore 264 can be tapered and the base bore 156 can be non-tapered.

In some cases, a recessed region can be provided within a bore in a connector body, as can receive a conductor during installation and potentially guide (or limit) deformation thereof by a plug. For example, in the configuration shown in FIGS. 3 and 4, the first base bore inner end 260 includes a recessed crimping region 280. In particular, the crimping region 280 and the crimping face 188 of the plug 108 are sized and aligned relative to each other to cooperatively deform the conductor 192 into the crimping region 280 (as shown in dashed lines for the conductor 192). This mechanical deformation of the conductor 192 into the crimping region 280 can help to more securely retain the conductor 192 within the connector system 200. In other examples, similar recessed regions can be provided at other locations, including at the cap inner end 248. Likewise, although not shown in particular, one or both of the base 116 or the cap 120 as shown in FIG. 1 may have similar crimping regions.

In the example illustrated in FIGS. 3 and 4, the second base bore 264 is sized and configured to receive a grounding rod (not shown), including as can be effectively secured by the tapered profile of the sidewall 268. In some cases, other bodies can be received in the bore 264, including another plug similar or substantially identical to the plug 108 that is received in the first base bore 156.

As noted above, a shoulder or other stop on a plug can help prevent over-insertion of the plug into a connector body, including as shown relative to the base 116 in FIG. 4. In some cases, while arranged in the assembled configuration, the first cap end 236 of the cap 120 can contact the base end 252 to provide a similar stop (e.g., relative to insertion of the plug 108 into the bore 158). However, in some assembled configurations (e.g., as shown in FIGS. 3 and 4), opposing connector bodies may not touch and a central portion of the plug may be exposed.

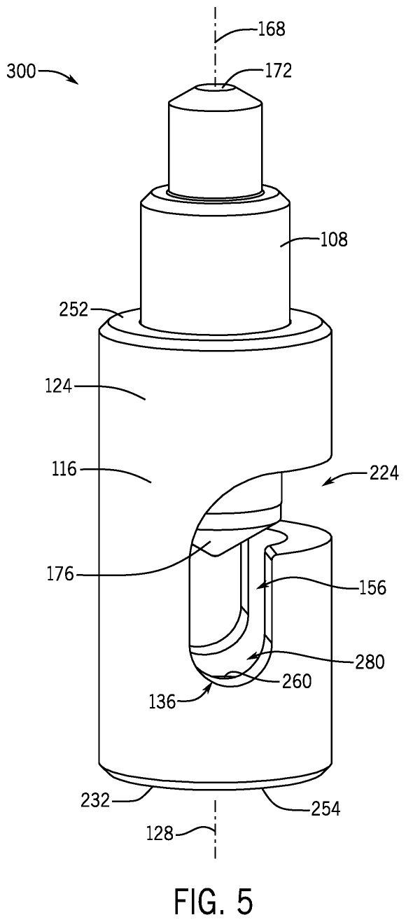

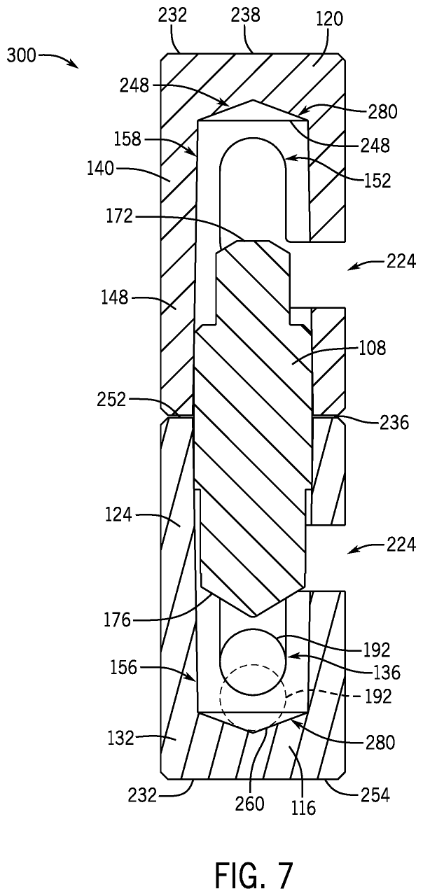

FIGS. 5-7 illustrate an example configuration of another connector system 300. As shown in FIGS. 6 and 7, the connector system 300 includes the plug 108 disposed between the base 116 that includes the lay-in slot 224 and does not include the second base bore 264 (see FIG. 4) and the cap 120 that also includes the lay-in slot 224. Thus, with the connector system 300 in an assembled configuration (shown) in FIGS. 6 and 7), the connector system 300 can provide a two-sided lay-in configuration, with the lay-in slots 224 in each of the base 116 and the cap 120 forming respective lay-in connector channels for respective sets of one or more conductors.

FIG. 5 illustrates a sub-assembled configuration of the connector system 300, including only the plug 108 and the base 116. Such sub-assembled configuration can be used, for example, in combination with the cap 120 as shown in FIGS. 6 and 7, or as part of other configurations of connector systems generally discussed herein (e.g., with the plug 108 in a reversed orientation, as a sub-assembly to replace the cap 120 and the plug 108 of FIG. 1, or with the cap 120 having other configurations disclosed herein). In the example illustrated in FIGS. 6 and 7, the first base end 252 of the base body 124 and the first cap end 236 of the cap body 140 can contact each other when the connector system 300 is arranged into the assembled configuration (as shown in FIGS. 6 and 7), although other configurations are possible.

As shown in FIGS. 4 and 7 in particular, one or both of the base 116 and the cap 120 of the connector systems 100, 200, 300 can also include a crimping region 280 that can be defined by an inner end of the base bore 156 or the cap bore 158 For example, as shown in FIG. 7, both the base 114 and the cap 120 of the connector system 300 include the crimping region 280. In particular, the crimping region 280 of the base 114 is located at the inner end 260 of the base bore 156 and at a distance from the base conductor channel 136 that corresponds to an inner end of the lay-in slot 224 of the base 116. Similarly, the crimping region of the cap 114 is located at the inner end 248 of the cap bore 158 and at an axial distance from the cap conductor channel 152 that corresponds to an inner end of the lay-in slot 224 of the cap 120. Thus, as similarly described above and in further detail below, advancing the plug 108 into either the base or cap bores 156, 158 can crimp a conductor into the corresponding crimping region 280 and thereby more securely connect the conductor to the larger connector system. Also as similarly discussed above, the cap 120 as shown FIG. 1 may also have a similar crimping region as the cap 120 shown in FIGS. 4 and 7.

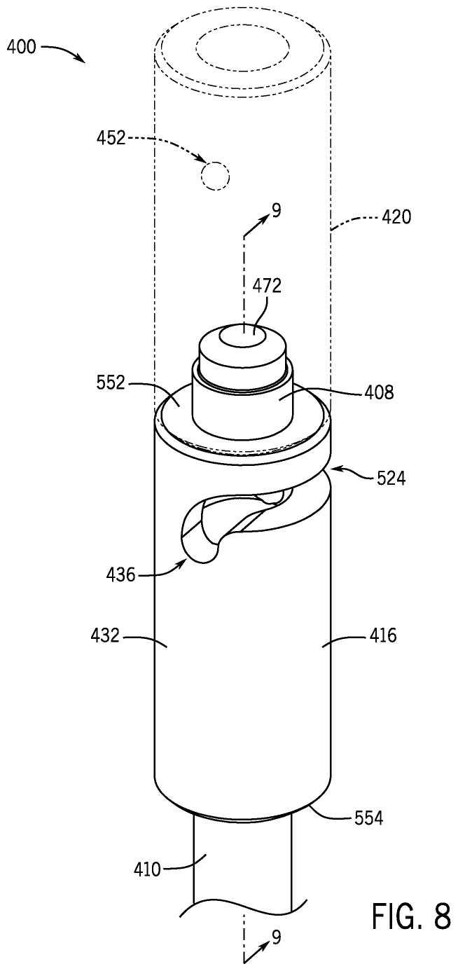

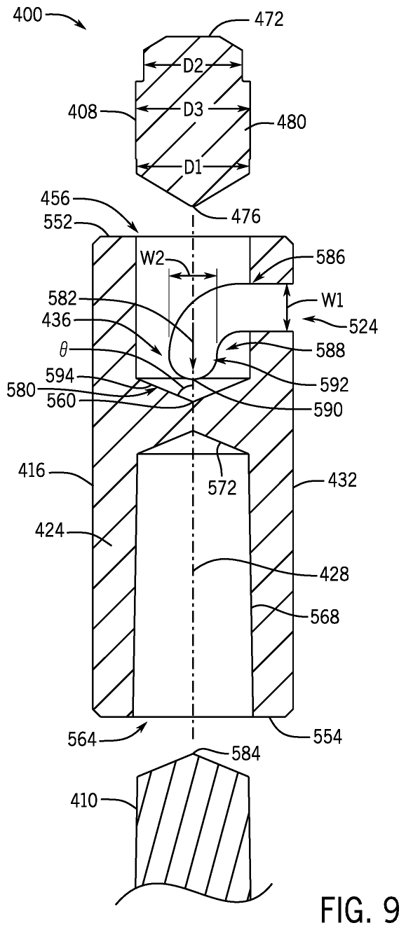

As generally noted above, some configurations of a connector system may include (or not include) components other than the components shown in the example connector system 100 of FIG. 1, connector system 200 of FIGS. 3-5, or connector system 300 of FIGS. 6 and 7. In this regard, FIGS. 8 and 9 illustrate another example connector system 400 (e.g., another configuration of the system 100) that includes a grounding base 416, a plug 408, and a grounding rod 410. In some examples, the connector system 400 can further include a cap 420 (shown partly schematically, in phantom lines). For example, the cap 420 can have geometry as variously discussed above, or can be configured similarly to the base 416. In this regard, although a conductor channel 452 in the cap 420 is schematically shown as a circular channel, a lay-in slot can be included in some examples (e.g., similar to a lay-in slot as shown for the base 416).

The connector system 400 of FIGS. 8 and 9 is another particular example of the connector systems 100, 200, 300 of FIGS. 1-7. To that end, features of connector system 400 described below include reference numbers that are generally similar to those used in FIGS. 1-7. For example, the base 416 of the connector system 400 is described as having a base conductor channel 436, just as the base 116 of the connector systems 100, 200, 300 has the conductor channel 136. Correspondingly, discussion above of the connector systems 100, 200 300 generally also applies relative to the example of FIGS. 8 and 9.

As shown in FIG. 9 in particular, the base 416 has a base body 424 with a first base end 552, a second base end 554 opposite the first base end 552, and a base axis 428 that extends through the first and second base ends 552, 554 and defines an axial direction (as indicated by arrow 582 in FIG. 9). A first base bore 456 of the base body 424 extends axially into the first base end 552 and a second base bore 564 of the base body 424 extends axially into the second base end 554, opposite the first base bore 456. In the illustrated example, the first and second base bores 456, 564 are co-axially aligned along the base axis 428 although other configurations are possible.

In the illustrated example, the plug 408 has a first end 476, a second end 472 opposite the first end 476, and a central portion 480 disposed between the first and second ends 476, 472. The first end 476 of the plug 408 has a first diameter D1 sized to be received within the first base bore 456. Further, in the illustrated example, the second end 472 of the plug 408 has a second diameter D2 that is different than the first diameter D1 of the first end 476 of the plug 408. For example, in some cases, the second diameter D2 of the second end 472 of the plug 408 can be sized to be received within a cap bore (not shown) of the cap 420 (see FIG. 8). In some examples, the central portion 480 of the plug 408 can have a third diameter D3 that is different than one or both of the first and second diameters D1, D2 of the first and second ends 476, 472, respectively, of the plug 408.

In some cases, a shoulder or other feature of the plug 408 can be configured to provide a positive stop to prevent insertion of plug 408 into the first base bore 456 of base 416 past a predefined axial distance. In some cases, a shoulder or other feature of the plug 408 can provide a visual indicator of appropriate insertion depth (e.g., at the transition between diameters D2 and D3). In some cases, a difference in diameters can provide for improved staging (e.g., centering) of the plug 408 in a bore before hammering (e.g., at the transition between the diameters D1 and D3).

Referring still to FIG. 9, the second base bore 564 has a second base bore sidewall 568 and a second base bore inner end 572. A first end 584 of the grounding rod 410 is sized to be received and secured within the second base bore 564, whereas a second end (not shown) of the grounding rod 410 opposite the first end 584 can be configured to be inserted and secured within a grounding surface (not shown). In other words, the second base bore 564 can be configured to secure the first end 584 of the grounding rod 410 to connect the base 416 (and attached conductors) to ground. In the illustrated example, the second base bore sidewall 568 tapers outwardly relative to a perspective extending outward from the second base bore inner end 572 (e.g., downwardly as shown). In other examples, the base 416 can include other profiles or other known arrangements to secure the first end 584 of the grounding rod 410 within the second base bore 564.

The base 416 further includes a lay-in slot 524 that opens at a sidewall 432 of the base body 424, and a base conductor channel 436 that is formed by the lay-in slot 524 and intersects the first base bore 456. In the illustrated example, the base conductor channel 436 is configured to receive a longitudinal portion of a conductor (e.g., a longitudinal portion of one of the wires 192 in FIGS. 11A and 11B) so that the conductor extends through the base conductor channel 436 and intersects the first base bore 456. More specifically, in the illustrated example, the lay-in slot 524 has a first portion 586 extending into the sidewall 432 of the base body 424 transverse (e.g., substantially perpendicular) to the base axis 428 and a second portion 588 extending from the first portion 586 along the first base bore 456 (e.g., substantially parallel to the base axis 428). An inner (blind) end 590 of the second portion 588 of the lay-in slot 524 defines a seat portion 592 of the base conductor channel 436 that receives a conductor when the connector system 400 is in the assembled configuration (as shown in FIG. 8 (conductor not shown)).

As best shown in FIG. 9, the first portion 586 of the lay-in slot 524 has a first width W1 and the second portion 588 of the lay-in slot 524 has a second width W2. In the illustrated example, the first width W1 of the first portion 586 is the same as the second width W2 of the second portion 588 of the lay-in slot 524. In some cases, the first width W1 of the first portion 586 can be different (e.g., larger) than the second width W2 of the second portion 588 of the lay-in slot 524. In some cases, the inner end 590 of the second portion 588 of the lay-in slot 524 (i.e., the seat portion 592 of the base conductor channel 436) can have a width that is the same as at least the second width W2 of the second portion 588 of the lay-in slot 524. In other cases, the width of the seat portion 592 of the base conductor channel 436 can be different than both the first and second widths W1, W2 of the first and second portions 586, 588 of the lay-in slot 524.

In an assembled configuration (e.g., as shown in FIG. 8), the first end 476 of the plug 408 extends into the first base bore 456, aligned with the conductor along the base axis 428 to deform the conductor in the axial direction 582 (e.g., as similarly shown in FIG. 7, with deformed conductor 192). Accordingly, in the illustrated example, the inner end 590 of the second portion 588 of the lay-in slot 524 is axially aligned with the base axis 428. Further, an inner end 560 of the first base bore 456 defines a crimping area 580 that extends axially past the seat portion 592 of the base conductor channel 436 to receive the axial deformation of the conductor. In the illustrated example, the crimping area 580 includes a conical surface 594 extending axially at the inner end 560 of the first base bore 456. In some examples, an angle θ (see FIG. 9) of the conical surface 594 of the first base bore 456 measured relative to the base axis 428 can be in a range between about 55 degrees and about 70 degrees, inclusive.

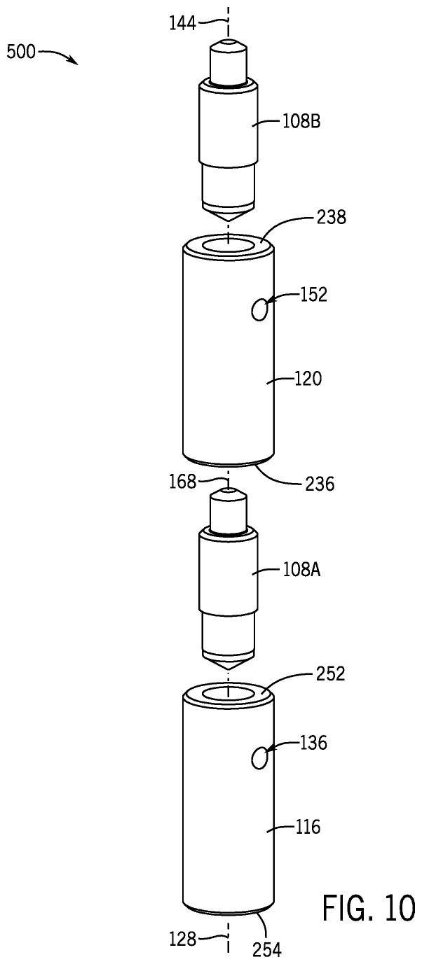

As mentioned above, in some examples, components of a connector system can be arranged in various orientations to provide for various orientations of two or more conductors. For example, FIG. 10 illustrates another connector system 500 that includes a stacked arrangement in which the cap 120 is substantially identical to the base 116. A first plug 108A can be received into the first end 252 of the base 116 and into a first end 236 of the cap 120, similar to the plug 108 of the connector systems 100, 200, 300 in FIGS. 1-7. The second plug 108B, as needed, can be received into the second end 238 of the cap 120.

In this regard, for example, the first (e.g., lower or middle) plug 108A is engaged with the base 116 to form a first (e.g., lower) sub-assembled configuration, and the second (e.g., upper) plug 108B is engaged with the cap 120 to form a second (e.g., upper) sub-assembled configuration. Further, the first and second sub-assembled configurations are arranged so that the first plug 108A can be received into opposing bores of both the base 116 and the cap 120 (i.e., the first base bore 156 and the first cap bore 158) and thereby secure the first and second sub-assemblies together to place the connector system 500 into one or more assembled configurations (as shown in FIGS. 11A and 11B). For example, assembly of the first and second sub-assemblies together can be achieved by aligning each of the base axis 128 of the base 116, the cap axis 144 of the cap 120, and the plug axes 168 of each of the plugs 108A, 108B, inserting the first plug 108 into the first base bore 156 of the base 116 and the first cap bore 158 (see FIG. 4) of the cap 116 and then hammering or otherwise striking the exposed end of the second plug 108B (or exposed ends of one the base 116 or the cap 120) to secure the two sub-assemblies in a stacked configuration (e.g., as shown in FIGS. 11A and 11B) of the connector system 500.

In the example of FIG. 10, the conductor channels 136, 152 are represented schematically as circular openings, various configurations are possible. For example, as noted above, the conductor channels 136, 152 can be circular bores that extend radially (or otherwise) through the base 116 and the cap 120 to intersect the respective bores for the plugs 108A, 108B. As another example, one or more both of the conductor channels 136, 152 can include lay-in conductor channels (e.g., as illustrated for the example of FIG. 9).

FIGS. 11A and 11B illustrate the connector system 500 assembled into respective first and second assembled configurations, respectively, with conductors 192 inserted through the respective base conductor channel 136 of the base 116 and the cap conductor channel 152 of the cap 120. As noted above, although schematically illustrated as circular in FIGS. 11A and 11B, the conductor channels 136, 152 can be formed as lay-in slots, or otherwise.

In the first assembled configuration of FIG. 11A, the base 116 and the cap 120 are arranged with rotational orientation relative to each other about the base axis 128 so that the conductors 192 disposed within the base conductor channel 136 and the cap conductor channel 152 extend in parallel (or substantially in parallel) relative to each other. In other words, in the first assembled configuration, the base 116 is arranged at a first rotational angle around the base axis 128 that is the same as a second rotational angle of the cap 120, as measured at reference axes defined by the conductors 192 within the channels 136, 152.

In the second assembled configuration of FIG. 11B, the base 116 and the cap 120 are arranged relative to each other about the base axis 128 such that the conductors 192 disposed within the base conductor channel 136 extend transverse (e.g., perpendicular or substantially perpendicular) to the conductors 192 disposed within the cap conductor channel 152. In other words, in the second assembled configuration, the first rotational angle of the base 116 around the base axis 128 is offset (e.g., by 90 degrees) from the second rotational angle of the cap 120 along the base axis 128. In various example, conductors can be oriented at various different angles to one another (e.g., neither parallel nor perpendicular). In this way, various stacked configurations of the connector system 500 can be used to electrically connect conductors 192 that extend in a wide variety of directions. Particularly when the conductor channels 136, 152 are configured as lay-in slots, this may allow for a high degree of flexibility in the interconnection of various conductors.

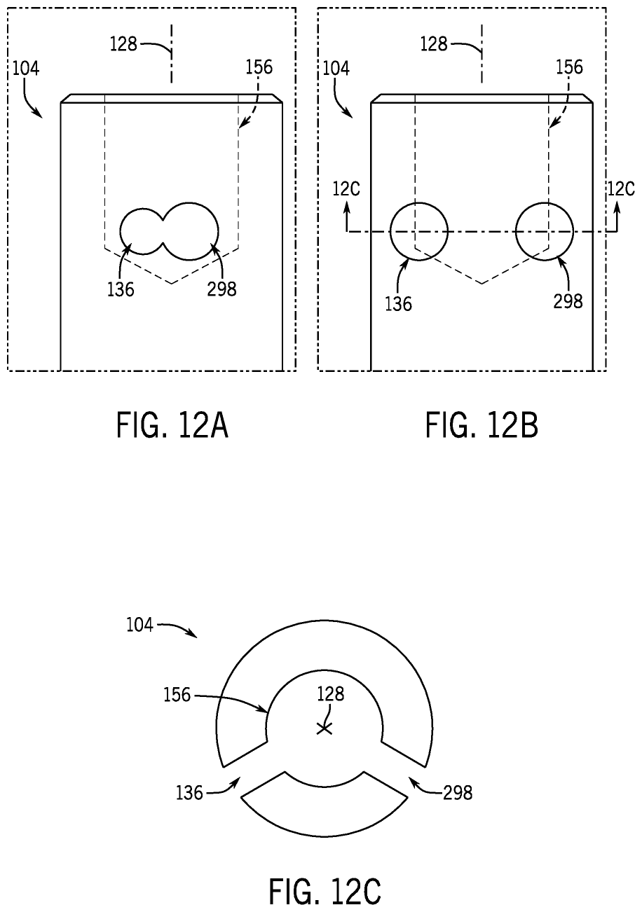

In different implementations, differently oriented conductor channels can allow secure engagement of different arrangements or numbers of conductors. In this regard, FIGS. 12A-12C illustrate various example arrangements of conductor channels of one of the connector bodies 104 (e.g., the base 116 as shown in FIGS. 12A-12C). For example, as shown in FIGS. 12A-12C, some configurations of the connector body 104 can include the base conductor channel 136 (i.e., a first base conductor channel) as well as a second base conductor channel 298 (e.g., as can accommodate two different sets of one or more conductors). In some cases, as shown in FIG. 12A in particular, different conductor channels on a connector body can exhibit different sizes, including as can accommodate different sizes or numbers of conductors. In some cases, as shown in FIGS. 12B and 12C in particular, the base conductor channels 136, 298 can be arranged to not extend in parallel with each other.

Thus, some examples of the disclosed technology can provide improved systems for grounding and other electrical connections. For example, a plug and associated connector bodies can be easily and reliably mechanically secured together, in a variety of arrangements, to form a robust electrical connection between the multiple conductors. Thus, for example, through interchangeable use of various plugs and connector bodies (e.g., caps and bases), some implementations of the disclosed technology can readily provide customizable stacked and other ganged configurations for conductors. Further, some implementations can be flexibly used to interconnect various connection subassemblies, to connect multiple conductors together, and to add more conductors to expand a connector system after an initial installation (or previous expansion). In some cases, utilizing a limited number of types of substantially identical plugs, substantially identical bases, and substantially identical caps (e.g., each manufactured as a respective integrally-formed component) can provide a high degree of flexibility for installation, while also reducing the amount of inventory necessary to produce a wide variety of electrical connections.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The term “about,” as used herein, refers to variation in the numerical quantity that may occur, for example, through typical measuring and manufacturing procedures used for articles of footwear or other articles of manufacture that may include examples of the disclosure herein; through inadvertent error in these procedures; through differences in the manufacture, source, or purity of the ingredients used to make the compositions or mixtures or carry out the methods; and the like. Throughout the disclosure, the terms “about” and “approximately” refer to a range of values±5% of the numeric value that the term precedes.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “integral” and derivatives thereof (e.g., “integrally”) describe elements that are manufacture as a single piece without fasteners, adhesive, or the like to secure separate components together. For example, an element stamped as a single-piece component from a single piece of sheet metal, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein, unless otherwise defined or limited, the term “lateral” refers to a direction at least a component of which does not extend in parallel with a reference direction. In some cases, a lateral direction can be a radial (i.e., perpendicularly outward) direction relative to an axis that extends in a reference direction.

Also as used herein, unless otherwise defined or limited, reference to alignment “along” an axis or other reference line, and the like, indicates that each of the relevant components is on the relevant axis or reference line, i.e., is intersected by the axis or line. Thus, for example, a plug and a conductor that are aligned along a common axis may be both located on the common axis and movable along the common axis to contact each other.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction. Similarly, as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

As noted previously, it will be appreciated by those skilled in the art that while the disclosed technology has been described above in connection with particular implementations and examples, the disclosure is not necessarily so limited, and that numerous other implementations, examples, uses, modifications and departures from the implementations, examples and uses are intended to be encompassed by the claims attached hereto. The entire disclosure of each patent and publication cited herein is incorporated by reference, as if each such patent or publication were individually incorporated by reference herein. Various features and advantages of the disclosed technology are set forth in the following claims.

I/We claim:

1. A connector system to provide electrical grounding connections, the connector system comprising:
a base that includes a base body, a base bore extending into the base body along a base axis that defines an axial direction, a lay-in slot that opens at a sidewall of the base body and forms a base conductor channel that intersects the base bore; and
a plug that includes a first end with a first diameter sized to be received in the base bore, and a second end, axially opposite the first end;
the base conductor channel receiving a longitudinal portion of a conductor into the lay-in slot at the sidewall so that the conductor extends through the base conductor channel to intersect the base bore; and
in an assembled configuration, the first end of the plug extending into the base bore, with the plug aligned with the conductor along the base axis to deform the conductor in the axial direction.

2. The connector system of claim 1, wherein the lay-in slot has a first portion extending into the sidewall of the base body substantially perpendicular to the base axis and a second portion extending from the first portion substantially parallel to the base axis and along the base bore; and
wherein an inner end of the second portion of the lay-in slot defines a seat portion of the base conductor channel that receives the conductor in the assembled configuration.

3. The connector system of claim 2, wherein the first portion of the lay-in slot has a first width and the second portion of the lay-in slot has a second width that is the same as the first width.

4. The connector system of claim 2, wherein the inner end of the second portion of the lay-in slot is axially aligned with the base axis.

5. The connector system of claim 4, wherein base bore defines a crimping area that extends axially past the seat portion of the base conductor channel to receive the axial deformation of the conductor.

6. The connector system of claim 5, wherein the crimping area includes a conical surface that extends axially at an inner end of the base bore.

7. The connector system of claim 6, wherein an angle of the conical surface of the base bore measured relative to the base axis is in a range between about 55 degrees and about 70 degrees, inclusive.

8. The connector system of claim 1, further comprising:
a grounding rod having a first end coupled to the base at one end and a second end insertable into a ground surface.

9. The connector system of claim 8, wherein the base bore is a first base bore extending axially into the base body at a first axial end; and
wherein the base further includes a second base bore extending axially into the base body at a second axial end opposite the first axial end, the second base bore receiving the first end of the grounding rod.

10. The connector system of claim 9, wherein the second base bore is a tapered bore, and the first base bore is not a tapered bore.

11. The connector system of claim 1, further comprising:
a cap that includes a cap body, a cap bore extending axially into the cap, and a cap conductor channel that intersects the cap bore;
wherein the conductor is a first conductor;
wherein the second end of the plug has a second diameter sized to be received within the cap bore; and
wherein, in the assembled configuration, the second end of the plug is secured in the cap bore, aligned with the cap conductor channel along the base axis to deform a second conductor extending through the cap conductor channel.

12. The connector system of claim 11, wherein the lay-in slot of the base is a first lay-in slot; and
wherein the cap conductor channel is formed by a second lay-in slot that opens at a sidewall of the cap body, the second lay-in slot being configured to receive a longitudinal portion of the second conductor so that the second conductor extends through the cap conductor channel to intersect the base bore.

13. The connector system of claim 11, wherein the cap conductor channel is formed by a first conductor bore and a second conductor bore that extend into opposing sides of the cap body and intersect the cap bore.

14. The connector system of claim 13, wherein an axis defined by the first conductor bore is substantially parallel to an axis defined by the second conductor bore.

15. The connector system of claim 11, wherein the first diameter of the first end of the plug is larger than the second diameter of the second end of the plug.

16. The connector system of claim 11, wherein the plug further includes a central portion with a third diameter larger than the first diameter, and the central portion of the plug is seated on the base in the assembled configuration.

17. A method of electrically grounding one or more conductors, the method comprising:
inserting a longitudinal portion of a conductor into a lay-in slot that opens at a sidewall of a base body of a connector system;
sliding the longitudinal portion of the conductor along a base conductor channel formed by the lay-in slot, so that the conductor intersects a first base bore, the first base bore extending in an axial direction along a base axis into the base body, from a first end of the base body; and
inserting a first end of a plug of the connector system into the base bore at the first end of the base body; and
hammering a second end of the plug, opposite the first end, to place the connector system in an assembled configuration in which a first diameter of the plug is secured within the first base bore and of the first end of the plug is aligned with the conductor along the base axis to deform the conductor in the axial direction.

18. The method of claim 17 further comprising:
before hammering the second end of the plug, inserting an end of a grounding rod into a second base bore of the base body that extends into the base body at a second end of the base body, opposite the first end.

19. A connector system to provide electrical grounding connections, the connector system comprising:
a base that includes a base body, a first base bore extending into the base body along a base axis at a first axial end of the base, a second base bore extending axially into the base body at a second axial end opposite the first axial end, and a base conductor channel that is formed by a lay-in slot and intersects the base bore;
a plug that includes a first end sized to be received in the base bore, and a second end, axially opposite the first end; and
a grounding rod with a first end received with the second base bore and a second end insertable into a ground surface;
the lay-in slot including an opening at a sidewall of the base body to receive a longitudinal portion of a conductor into the base conductor channel, a first portion extending from the opening transverse to the base axis and a second portion extending from the first portion along the base bore to a seat portion at an inner end of the lay-in slot; and
in an assembled configuration, the longitudinal portion of the conductor being seated on the seat portion and the first end of the plug extending within the base bore to deform the conductor axially past the seat portion.

20. The connector system of claim 19, further comprising:
a cap that includes a cap body, a cap bore extending axially into the cap body, and a cap conductor channel that intersects the cap bore;
wherein the conductor is a first conductor;
wherein the second end of the plug is sized to be received within the cap bore; and
wherein, in the assembled configuration, the second end of the plug extends within the cap bore to deform a second conductor that extends through the cap conductor channel.
